(19) United States
(12) Patent Application Publication
(10) Pub. No.: US 2018/0297127 A1
(43) Pub. Date: Oct. 18, 2018

(54) MILLING TOOL, CUTTING METHOD, AND METHOD OF MANUFACTURING MILLING TOOL

(71) Applicant: SUMITOMO ELECTRIC HARDMETAL CORP., Itami-shi (JP)

(72) Inventors: Hitoshi Tohkairin, Yokohama-shi (JP); Yasuhiro Tan, Yokohama-shi (JP)

(21) Appl. No.: 15/767,187

(22) PCT Filed: Jun. 29, 2016
(86) PCT No.: PCT/JP2016/069229

§ 371 Date: Apr. 10, 2018

(30) Foreign Application Priority Data
Nov. 10, 2015 (JP) 2015-220272

(51) Int. Cl. B23C 5/06; B23C 5/28; B23C 9/00; B23Q 11/10

(52) U.S. Cl. CPC B23C 5/06; B23Q 11/10; B23C 9/00; B23C 5/28

(57) ABSTRACT

A milling tool according to the present disclosure includes a tool body including an outer circumferential portion having an upper end and a lower end, and an end portion located at the lower end of the outer circumferential portion. An insert including a cutting edge is attached to the tool body so that the cutting edge protrudes from the end portion. Further, the milling tool according to one aspect of the present invention includes a cover surrounding the outer circumferential portion, with a gap lying between the outer circumferential portion and the cover. The tool body includes a first jetting port in the outer circumferential portion, the first jetting port being configured to allow a coolant to jet into the gap between the outer circumferential portion of the tool body and the cover.

### TECHNICAL FIELD

The present invention relates to a milling tool, a cutting method, and a method of manufacturing a milling tool.

The present application claims priority to Japanese Patent Application No. 2015-220272 filed on Nov. 10, 2015, the disclosure of which is hereby incorporated by reference in its entirety.

### BACKGROUND ART

A technology for cutting flat planes using, for example, a milling machine with a milling tool has been conventionally well-known. Such a milling tool includes a tool body having an outer circumferential portion, and inserts attached to the outer circumferential portion.

Such a milling tool is attached to an arbor through an attaching hole provided in the center of the tool body. The milling tool is fitted on the main shaft of a machine tool, such as a milling machine, using a pull-stud bolt, and is thus fixed to the arbor. In this state, the machine tool rotates the main shaft, and presses the cutting edges of the inserts attached to the milling tool against a workpiece, so as to cut a flat plane.

During such cutting of a flat plane, chip is generated from a workpiece. If no measure against the scattering of chip is taken, the generated chip is scattered upward due to the influences of centrifugal force and rake angle. The scattered chip accumulates in the machine tool. In order to clear away the chip that has accumulated in the machine tool, the machine tool needs to be stopped. Accordingly, the accumulation of too much chip in the machine tool decreases the operating rate of the machine tool.

Regarding such a problem of chip scattering, a technology for reducing the scattering of chip has conventionally been proposed. For example, a milling tool described in PTD 1 includes a tool body having an outer circumferential portion, inserts attached to the outer circumferential portion, a cover provided at the outer circumferential portion of the tool body so as to cover the tool body, and a suction mechanism for sucking air between the cover and the outer circumferential portion of the tool body.

The milling tool described in PTD 1 sucks and collects the chip generated from a workpiece through the space between the cover and the lateral face of the tool body. Thus, the milling tool described in PTD 1 can reduce the scattering of chip to the environment.

### CITATION LIST

### Patent Document

PTD 1: Japanese Utility Model Laying-Open No. 7-27736

### SUMMARY OF INVENTION

### Solution To Problem

A milling tool according to one aspect of the present invention includes a tool body including an outer circumferential portion having an upper end and a lower end, and an end portion located at the lower end of the outer circumferential portion. An insert including a cutting edge is attached to the tool body so that the cutting edge protrudes from the end portion. Further, the milling tool according to one aspect of the present invention includes a cover surrounding the outer circumferential portion, with a gap lying between the outer circumferential portion and the cover. The tool body includes a first jetting port in the outer circumferential portion, the first jetting port being configured to allow a coolant to jet into the gap between the outer circumferential portion of the tool body and the cover.

### BRIEF DESCRIPTION OF DRAWINGS

FIG. 1 is a top view of a milling tool according to the first embodiment.

FIG. 2 is a side view of the milling tool according to the first embodiment.

FIG. 3 is a partial sectional view of the milling tool according to the first embodiment.

FIG. 4 is a bottom view of the milling tool according to the first embodiment.

FIG. 5 is a schematic view of a milling machine with the milling tool according to the first embodiment.

FIG. 6 is a partial sectional view of a milling tool according to the second embodiment.

### DESCRIPTION OF EMBODIMENTS

### Problems to be Solved by the Disclosure

The milling tool described in PTD 1 sucks and collects chip, and thus requires, for example, a filter to be provided within the suction mechanism. Therefore, such a milling tool cannot be applied to wet cutting. The present disclosure has been made in view of such a problem with the conventional technology and aims to provide a milling tool, a cutting method, and a method of manufacturing a milling tool that can reduce the scattering of chip even in wet cutting.

### Advantageous Effects of the Disclosure

According to the above, the scattering of chip can be reduced even in wet cutting.

### Description of Embodiments of the Invention

First of all, embodiments of the present invention are listed and described.

(1) A milling tool according to one aspect of the present invention includes a tool body including an outer circumferential portion having an upper end and a lower end, and an end portion located at the lower end of the outer circumferential portion. The milling tool according to one aspect of the present invention includes an insert including a cutting edge and attached to the tool body so that the cutting edge protrudes from the end portion. The milling tool according to one aspect of the present invention includes a cover surrounding the outer circumferential portion, with a gap lying between the outer circumferential portion and the cover. The tool body includes a first jetting port in the outer circumferential portion, the first jetting port being configured to allow a coolant to jet into the gap between the outer circumferential portion and the cover.

According to such a configuration, a coolant jetting from the first jetting port blows off the chip, which has been generated by cutting, in a certain direction. Therefore, the scattering of chip can be reduced even in wet cutting.

(2) In the milling tool of (1), the tool body includes a second jetting port configured to allow a coolant to jet toward the cutting edge of the insert.

According to such a configuration, a coolant is supplied to the area around the cutting edge of the insert, thus reducing the temperature rise of the cutting edge of the insert. Therefore, the tool life of the insert can be prolonged. Further, according to such a configuration, a coolant supplied to the area around the cutting edge of the insert shatters the generated chip to pieces. Therefore, the chip can be more easily blown off

(3) In the milling tool of (2), the tool body includes a recess portion recessed at both the outer circumferential portion and the end portion. The insert is disposed in the recess portion. The second jetting port is open into the recess portion.

According to such a configuration, the tool life of the insert can be prolonged. Also, the chip can be more easily blown off

(4) In the milling tool of (2) or (3), the first jetting port and the second jetting port are different from each other in opening diameter.

According to such a configuration, a jet of coolant can be adjusted in accordance with the cutting conditions.

(5) In the milling tool of (2) to (4), the first jetting port and the second jetting port are configured so that the coolant jetting from the first jetting port and the coolant jetting from the second jetting port are different from each other in pressure.

According to such a configuration, a jet of coolant can be adjusted in accordance with the cutting conditions.

(6) In the milling tool of (2) to (5), the tool body includes a first flow path in the tool body, the first flow path communicating with the first jetting port. The first flow path inclines so that a portion thereof closer to the first jetting port is located closer to the upper end.

According to such a configuration, a coolant is supplied to a part that is between the chip scatter cover and the tool-body lateral face and that is above the first jetting port. Therefore, the part subject to clogging with chip can be prevented from being clogged with chip.

(7) In the milling tool of (6), the tool body includes a second flow path in the tool body, the second flow path communicating with the second jetting port. The second flow path branches off from the first flow path.

According to such a configuration, a coolant supply path can be shared within the tool body. Therefore, the tool body can be more easily manufactured.

(8) The milling tool of (6) or (7) includes an orifice member disposed in the first flow path. The orifice member includes an orifice flow path communicating with the first flow path and forming the first jetting port. The orifice flow path is smaller than the first flow path in diameter.

According to such a configuration, the first jetting port can be made smaller than the second jetting port in opening diameter without complicated processing of the tool body. Therefore, the tool body can be more easily manufactured.

(9) In the milling tool of (1) to (8), a plurality of inserts are attached to the tool body. The tool body includes a plurality of first jetting ports. Each of the plurality of first jetting ports is provided corresponding to an associated one of the plurality of inserts.

According to such a configuration, a sufficient amount of coolant is jetted into the space between the chip scatter cover and the tool-body lateral face. Therefore, the chip can be more efficiently prevented.

(10) In the milling tool of (2) to (5), a plurality of inserts are attached to the tool body. The tool body includes a plurality of second jetting ports. Each of the plurality of second jetting ports is provided corresponding to an associated one of the plurality of inserts.

According to such a configuration, a coolant can be supplied to all the inserts. Therefore, the tool life can be further prolonged.

(11) In the milling tool of (1) to (10), an area is filled with a filling, the area being between the cover and the outer circumferential portion of the tool body and being above the first jetting port.

Such a configuration eliminates the part that a coolant cannot easily enter. Therefore, the part subject to clogging with chip can be prevented from being clogged with chip.

(12) The milling tool of (1) to (11) includes a cover fixing member attached to the tool body in the direction from the upper end to the lower end so as to attach the cover to the tool body.

According to such a configuration, the cover fixing member is not easily loosened by the centrifugal force caused by the rotation of the milling tool. This can prevent the cover from being blown away during cutting.

(13) In the milling tool of (1) to (12), the tool body includes a first tapered portion that becomes wider in the direction from the upper end to the lower end. The cover includes a second tapered portion that becomes wider in the direction from the upper end to the lower end. In the state where the cover is attached to the tool body, the first tapered portion is in contact with the second tapered portion.

According to such a configuration, the scatter prevention cover can be easily aligned with respect to the tool body. Therefore, when the scatter prevention cover is removed, for example, for replacement of an insert and is then attached again, the stability at the time of rotation of the tool is little impaired.

(14) In a cutting method according to one aspect of the present invention, a milling tool is rotated, the milling tool including a tool body having an outer circumferential portion, an insert attached to the tool body, and a cover surrounding the outer circumferential portion, with a gap lying between the outer circumferential portion and the cover. A water-soluble coolant is jetted from the outer circumferential portion of the tool body into the gap between the outer circumferential portion and the cover. The water-soluble coolant is jetted into the gap when the milling tool is rotated to cut a workpiece.

According to such a configuration, a coolant jetting from the first jetting port blows off the chip, which has been generated by cutting, in a certain direction. Therefore, wet cutting with reduced scattering of chip can be achieved.

(15) In a method of manufacturing a milling tool according to one aspect of the present invention, a tool body is prepared, the tool body including an outer circumferential portion having an upper end and a lower end, and an end portion located at the lower end of the outer circumferential portion. An outer circumferential surface of the tool body is drilled to form a jetting port in the outer circumferential surface of the tool body, the jetting port being configured to allow a coolant to jet. An insert including a cutting edge is attached to the tool body so that the cutting edge protrudes from the end portion. A cover is attached to the tool body so as to cover the jetting port, the cover surrounding the outer circumferential portion, with a gap lying between the outer circumferential portion and the cover.

According to such a configuration, the milling tool can be easily manufactured.

### Details of Embodiments of the Invention

The details of embodiments of the present invention are described below with reference to the drawings. In the drawings, identical or corresponding parts are denoted by identical characters. At least some of the features of the embodiments described below may be combined with each other arbitrarily.

### First Embodiment

### External Structure of Milling Tool According to First Embodiment

An external structure of a milling tool according to an embodiment is described below with reference to the drawings.

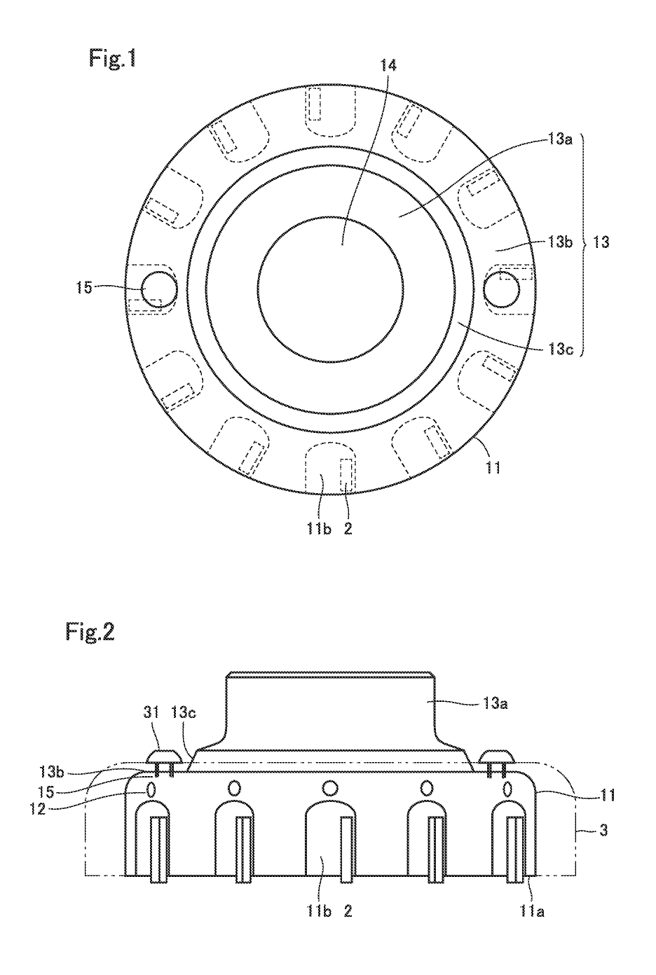

FIG. 1 is a top view of a milling tool according to the first embodiment. FIG. 2 is a side view of the milling tool according to the first embodiment. As shown in FIG. 1, the milling tool according to the present embodiment mainly includes a tool body 1, an insert 2, and a cover 3.

Tool body 1 has an outer circumferential portion 11 at its outer-circumferential lateral face. Outer circumferential portion 11 includes an upper end and a lower end. Tool body 1 includes an end portion 11a at the lower end of outer circumferential portion 11. Tool body 1 includes a plurality of recess portions 11b provided at regular intervals. At the areas where recess portions 11b are provided, both outer circumferential portion 11 and end portion 11a of tool body 1 are recessed. In outer circumferential portion 11 of tool body 1, a first jetting port 12 is provided. Preferably, a plurality of first jetting ports 12 are provided. Preferably, each of a plurality of first jetting ports 12 is provided corresponding to an associated one of a plurality of inserts 2 attached to tool body 1. Note that, however, the correspondence relation between inserts 2 and first jetting ports 12 is not limited as such. Tool body 1 is made of, for example, steel.

As shown in FIG. 1, tool body 1 includes an upper-side portion 13 on the upper end side of outer circumferential portion 11. Upper-side portion 13 includes an upper-side central portion 13a in its center, an upper-side circumferential portion 13b surrounding upper-side central portion 13a, and a first tapered portion 13c. First tapered portion 13c is provided at a part where upper-side central portion 13a extends upward from upper-side circumferential portion 13b. First tapered portion 13c becomes wider in the direction from the upper end to the lower end. As shown in FIG. 2, upper-side central portion 13a is higher than upper-side circumferential portion 13b.

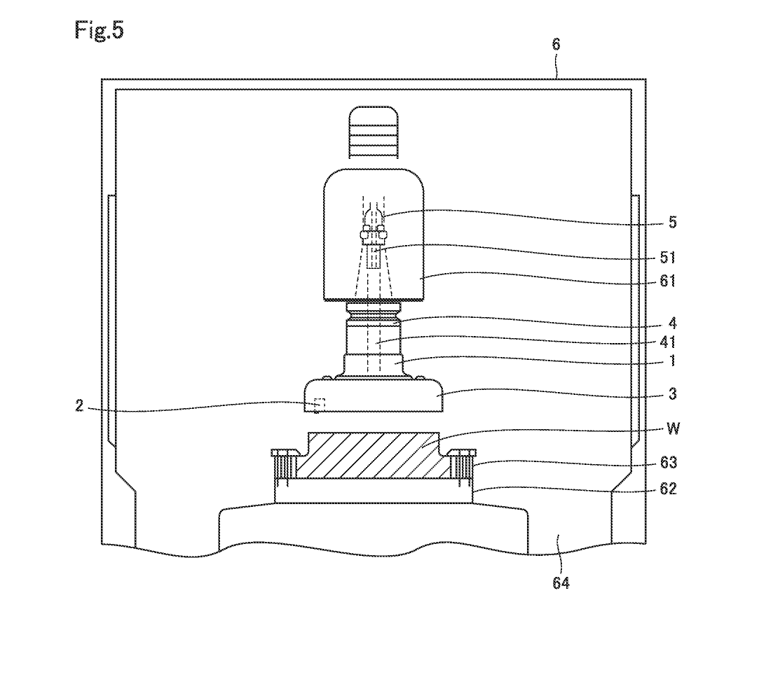

As shown in FIG. 1, in the center of upper-side central portion 13a, an attaching hole 14 for an arbor 4 (see FIG. 5) to be inserted therein is provided. Arbor 4 has a hollow structure 41 that is hollow along the axial direction. In upper-side circumferential portion 13b of tool body 1, a cover-attaching bolt hole 15 is formed.

As shown in FIG. 2, insert 2 is attached to recess portion 11b. Insert 2 includes a cutting edge for cutting a workpiece W. Insert 2 is fixed to recess portion 11b by being fastened with, for example, a bolt. The cutting edge of insert 2 protrudes from end portion 11a of outer circumferential portion 11 in the state where insert 2 is fixed to recess portion 11b. Insert 2 may be made of any material that is commonly used as a tool for metalworking. As the materials for insert 2, tool steel, cemented carbide, cermet, ceramic, and CBN (boron nitride) may be used, for example. Coatings may be applied to these materials for enhancing their respective abilities. The material and coating for insert 2 are chosen as appropriate according to the material for workpiece W and cutting conditions.

As shown in FIG. 1, cover 3 is fixed to tool body 1. Cover 3 is shaped in such a way that it covers first jetting port 12 provided in outer circumferential portion 11. Between cover 3 and outer circumferential portion 11 of tool body 1, a gap is present.

A cover fixing member 31 is passed through cover 3 and is fastened to cover-attaching bolt hole 15. Cover fixing member 31 is, for example, a bolt. Thus, cover 3 is fixed to tool body 1.

During cutting, tool body 1 rotates and thereby causes a centrifugal force toward the outer side in the radial direction of tool body 1. However, since cover fixing member 31 is inserted in cover-attaching bolt hole 15 along the direction from the upper end to the lower end of outer circumferential portion 11, cover fixing member 31 is little affected by such a centrifugal force. Therefore, the rotation of tool body 1 does not easily loosen cover fixing member 31.

In order to secure the stability during the rotation of the milling tool, cover 3 needs precise alignment with respect to tool body 1. In order to do so, the inner circumference of cover 3 may preferably have a second tapered portion 32 having a tapered shape that becomes wider in the direction from the upper end to the lower end. Second tapered portion 32 is in contact with first tapered portion 13c when cover 3 is attached to tool body 1. This enables easy and precise positioning of cover 3 with respect to tool body 1.

### Internal Structure of Milling Tool According to First Embodiment

An internal structure of a milling tool according to the embodiment is described below.

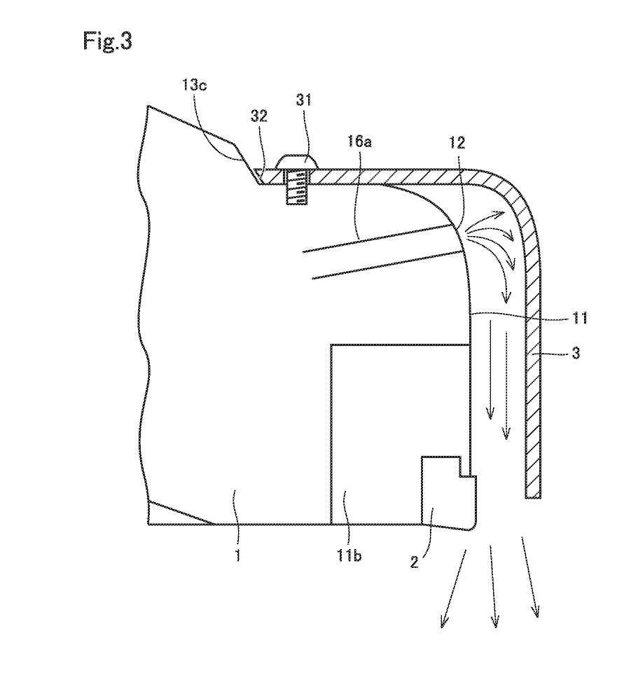

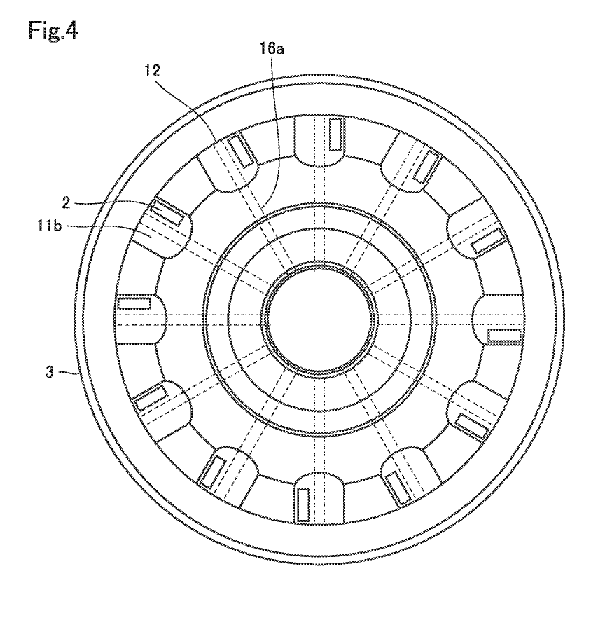

FIG. 3 is a partial sectional view of the milling tool according to the first embodiment. FIG. 4 is a bottom view of the milling tool according to the first embodiment. As shown in FIG. 3, tool body 1 includes a first flow path 16a extending in tool body 1. First flow path 16a is provided for a coolant to flow therethrough. First flow path 16a preferably extends in a straight line. As shown in FIG. 4, it is preferred that each of a plurality of first flow paths 16a be provided corresponding to an associated one of a plurality of inserts 2. As shown in FIG. 3, first flow path 16a connects to first jetting port 12. First flow path 16a communicates with hollow structure 41 when arbor 4 is inserted in attaching hole 14 (see FIG. 5). First flow path 16a is formed by, for example, drilling the outer circumferential portion of tool body 1.

First flow path 16a preferably inclines so that a portion thereof closer to first jetting port 12 is located closer to the upper end of outer circumferential portion 11. It is difficult for a water-soluble coolant that has jetted from first jetting port 12 to enter a part above first jetting port 12 in the gap between cover 3 and outer circumferential portion 11, and this part is therefore subject to clogging with chip. By inclining first flow path 16a as described above, however, a water-soluble coolant that has jetted from first jetting port 12 can easily enter this part. Thus, such a configuration can prevent the clogging of this part with chip.

### Operation of Milling Tool According to First Embodiment

The operation of a milling tool according to the embodiment is described below.

FIG. 5 is a schematic view of a milling machine with the milling tool according to the first embodiment. As shown in FIG. 5, milling machine 6 includes a main shaft 61, a table 62, a jig 63, and a chip discharging mechanism 64. Workpiece W is to be placed on table 62. Placed workpiece W is fixed to table 62 with jig 63. Workpiece W is preferably an aluminium alloy without limitation.

Pull-stud bolt 5 is fitted on main shaft 61. Arbor 4 is attached to pull-stud bolt 5. The milling tool is attached to arbor 4 by inserting arbor 4 in attaching hole 14 of the milling tool. In order to allow a coolant to flow, pull-stud bolt 5 has a hollow structure 51 that is hollow along the axial direction. Accordingly, with pull-stud bolt 5 being attached to arbor 4, hollow structure 51 of pull-stud bolt 5 communicates with hollow structure 41 of arbor 4.

Milling machine 6 rotates the milling tool by rotating main shaft 61. Milling machine 6 moves table 62, thereby pressing the cutting edge of insert 2 of the rotating milling tool against workpiece W. In this way, the cutting of workpiece W starts and chip is generated from workpiece W.

As soon as milling machine 6 starts the rotation of main shaft 61, milling machine 6 starts supplying a water-soluble coolant to hollow structure 51 of pull-stud bolt 5. As described above, hollow structure 41 of arbor 4 communicates with hollow structure 51 of pull-stud bolt 5, and first flow path 16a formed in tool body 1 communicates with hollow structure 41 of arbor 4. Accordingly, a water-soluble coolant jets from first jetting port 12 that connects to first flow path 16a.

A water-soluble coolant that has jetted from first jetting port 12 passes through the gap between cover 3 and outer circumferential portion 11 of tool body 1, and is then supplied to the area around the cutting edge of insert 2 and also jets toward workpiece W. The chip generated from workpiece W is blown off by a flow of water-soluble coolant. Thus, the generated chip is collected by chip discharging mechanism 64 provided below table 62 without flying up above table 62. In this way, the generated chip is prevented from being scattered in all directions.

### Second Embodiment

A milling tool according to the second embodiment is described below with reference to the drawings. Here, the differences from the milling tool according to the first embodiment described above are mainly discussed.

### Internal Structure of Milling Tool According to Second Embodiment

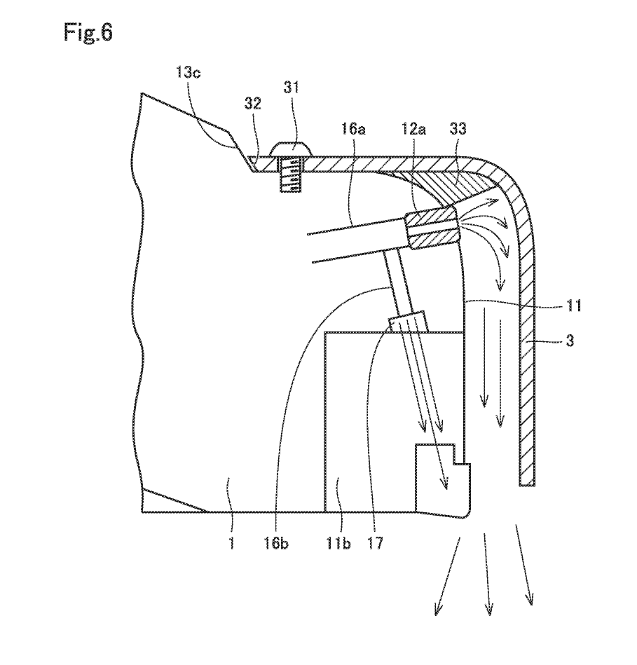

FIG. 6 is a partial sectional view of a milling tool according to the second embodiment. As shown in FIG. 6, unlike the first embodiment, the milling tool according to the second embodiment additionally includes a second jetting port 17 and an embedded material 33.

Second jetting port 17 is disposed at a position facing insert 2 in recess portion 11b. It is preferred that a plurality of second jetting ports 17 be provided. Also, it is preferred that each of a plurality of second jetting ports 17 be provided corresponding to an associated one of a plurality of inserts 2. Second jetting port 17 connects to a second flow path 16b branching off from first flow path 16a. Second flow path 16b is formed so as to extend in tool body 1. Second flow path 16b is formed by, for example, drilling at recess portion 11b.

In FIG. 6, second flow path 16b branches off from first flow path 16a. However, second flow path 16b may be a flow path independent of first flow path 16a. Note that, second flow path 16b branching off from first flow path 16a allows simplification of the internal structure of tool body 1, thus allowing easy manufacture of tool body 1.

As shown in FIG. 6, first jetting port 12 may be different from second jetting port 17 in opening diameter. Further, first jetting port 12 and second jetting port 17 may be configured so that a coolant jetting from first jetting port 12 is different from a coolant jetting from second jetting port 17 in pressure.

Preferably, first jetting port 12 is smaller than second jetting port 17 in opening diameter. In general, a jetting port having a small opening diameter allows a high flow speed and a high pressure of fluid jetting from the jetting port. In such a case, therefore, a coolant jetting from first jetting port 12 is higher than a coolant jetting from second jetting port 17 in flow speed and pressure.

The chip generated by cutting tends to be scattered upward from a cutting point. Accordingly, in order to reduce the scattering of chip, a coolant jetting from first jetting port 12 is preferably high in flow speed and pressure. Therefore, first jetting port 12 having the opening diameter as described above can more efficiently reduce the scattering of chip.

As shown in FIG. 6, first jetting port 12 may include an orifice 12a. Orifice 12a is disposed in first flow path 16a. Orifice 12a has a shape with a narrowed tip. Accordingly, the use of orifice 12a can make first jetting port 12 smaller than second jetting port 17 in opening diameter without complicated processing.

Preferably, second jetting port 17 is smaller than first jetting port 12 in opening diameter. In such a case, a coolant jetting from second jetting port 17 is higher than a coolant jetting from first jetting port 12 in flow speed and pressure.

A water-soluble coolant jetting form second jetting port 17 toward the cutting edge of insert 2 cools the cutting edge of insert 2. This cooling effect is greater with a higher flow speed of water-soluble coolant supplied to the cutting edge of insert 2. Accordingly, second jetting port 17 smaller than first jetting port 12 in opening diameter further reduces the temperature rise of the cutting edge of insert 2, thus prolonging the tool life of insert 2.

A water-soluble coolant jetting from second jetting port 17 toward the cutting edge of insert 2 shatters the chip, which has been generated by cutting, to pieces. This chip-shattering effect is greater with a higher flow speed and a higher pressure of water-soluble coolant supplied to the cutting edge of insert 2. The shattered chip is more easily blown off by a flow of water-soluble coolant jetting from first jetting port 12 than large pieces of chip. Accordingly, second jetting port 17 smaller than first jetting port 12 in opening diameter can further reduce the scattering of chip.

As shown in FIG. 6, embedded material 33 fills up a part above first jetting port 12 in the gap between cover 3 and outer circumferential portion 11. Embedded material 33 is made of, for example, resin putty.

It is difficult for a water-soluble coolant that has jetted from first jetting port 12 to enter the part above first jetting port 12 in the gap between cover 3 and outer circumferential portion 11. Accordingly, this part is subject to clogging with the chip generated by cutting. Filling this part with embedded material 33, however, eliminates the space subject to clogging with the generated chip. Therefore, filling this part with embedded material 33 can prevent the clogging with the generated chip. Note that, the part above first jetting port 12 in the gap between cover 3 and outer circumferential portion 11 may be filled with either cover 3 or tool body 1.

### Operation of Milling Tool According to Second Embodiment

The operation of a milling tool according to the second embodiment is described below.

In the second embodiment, a water-soluble coolant jets not only from first jetting port 12 but also from second jetting port 17, unlike the first embodiment.

Once the cutting of a flat plane using the milling tool starts, cutting heat is generated at the cutting edge of insert 2. With the generation of the cutting heat, the temperature of the cutting edge of insert 2 starts to rise. In the second embodiment, however, a water-soluble coolant jets from second jetting port 17 toward the cutting edge of insert 2. The water-soluble coolant supplied to the area around the cutting edge of insert 2 reduces the temperature rise of the cutting edge of insert 2. Therefore, according to the second embodiment, the tool life of the cutting edge of insert 2 can be prolonged compared to the first embodiment.

Further, the water-soluble coolant supplied from second jetting port 17 to the area around the cutting edge of insert 2 shatters the generated chip to pieces. The chip shattered to pieces is easily blown off by a water-soluble coolant jetting from first jetting port 12. Therefore, according to the second embodiment, the scattering of chip can be further reduced compared to the first embodiment.

It should be construed that the embodiments disclosed herein are given by way of example in all respects, not by way of limitation. It is intended that the scope of the present invention is defined by the claims, not by the above-described embodiments, and encompasses all modifications equivalent in meaning and scope to the claims.

### REFERENCE SIGNS LIST

1: tool body; 11: outer circumferential portion; 11a: end portion; 11b: recess portion; 12: first jetting port; 12a: orifice; 13: upper-side portion; 13a: upper-side central portion; 13b: upper-side circumferential portion; 13c: first tapered portion; 14: attaching hole; 15: cover-attaching bolt hole; 16a: first flow path; 16b: second flow path; 17: second jetting port; 2: insert; 3: cover; 31: cover fixing member; 32: second tapered portion; 33: embedded material; 4: arbor; 41: hollow structure of arbor; 5: pull-stud bolt; 51: hollow structure of pull-stud bolt; 6: milling machine; 61: main shaft; 62: table; 63: jig; 64: chip discharging mechanism; W: workpiece

1. A milling tool comprising:
a tool body including
an outer circumferential portion having an upper end and a lower end, and
an end portion located at the lower end of the outer circumferential portion;
an insert including a cutting edge and attached to the tool body so that the cutting edge protrudes from the end portion; and
a cover surrounding the outer circumferential portion, with a gap lying between the outer circumferential portion and the cover,
the tool body including a first jetting port in the outer circumferential portion, the first jetting port being configured to allow a coolant to jet into the gap between the outer circumferential portion of the tool body and the cover.

2. The milling tool according to claim 1, wherein the tool body includes a second jetting port configured to allow a coolant to jet toward the cutting edge of the insert.

3. The milling tool according to claim 2, wherein
the tool body includes a recess portion recessed at both the outer circumferential portion and the end portion,
the insert is disposed in the recess portion, and
the second jetting port is open into the recess portion.

4. The milling tool according to claim 2, wherein the first jetting port and the second jetting port are different from each other in opening diameter.

5. The milling tool according to claim 2, wherein the first jetting port and the second jetting port are configured so that the coolant jetting from the first jetting port and the coolant jetting from the second jetting port are different from each other in pressure.

6. The milling tool according to claim 2, wherein the tool body includes a first flow path communicating with the first jetting port and extending in the tool body, and
the first flow path inclines so that a portion thereof closer to the first jetting port is located closer to the upper end.

7. The milling tool according to claim 6, wherein
the tool body includes a second flow path communicating with the second jetting port and extending in the tool body, and
the second flow path branches off from the first flow path.

8. The milling tool according to claim 6, further comprising an orifice member disposed in the first flow path, wherein
the orifice member includes an orifice flow path communicating with the first flow path and forming the first jetting port, and
the orifice flow path is smaller than the first flow path in diameter.

9. The milling tool according to claim 1, wherein
a plurality of the inserts are attached to the tool body,
the tool body includes a plurality of the first jetting ports, and
each of the plurality of the first jetting ports is provided corresponding to an associated one of the plurality of the inserts.

10. The milling tool according to claim 2, wherein
a plurality of the inserts are attached to the tool body,
the tool body includes a plurality of the second jetting ports, and
each of the plurality of the second jetting ports is provided corresponding to an associated one of the plurality of the inserts.

11. The milling tool according to claim 1, wherein an area is filled with a filling, the area being between the cover and the outer circumferential portion of the tool body and being on a side where the upper end is disposed, relative to the first jetting port.

12. The milling tool according to claim 1, further comprising a cover fixing member attached to the tool body in a direction from the upper end to the lower end so as to attach the cover to the tool body.

13. The milling tool according to claim 1, wherein
the tool body includes a first tapered portion that becomes wider in a direction from the upper end to the lower end,
the cover includes a second tapered portion that becomes wider in the direction rom the upper end to the lower end, and
in a state where the cover is attached to the tool body, the second tapered portion is in contact with the first tapered portion.

14. A cutting method comprising:
rotating a milling tool, the milling tool including
a tool body having an outer circumferential portion,
an insert attached to the tool body, and
a cover surrounding the outer circumferential portion, with a gap lying between the outer circumferential portion and the cover; and jetting a water-soluble coolant from the outer circumferential portion of the tool body into the gap between the outer circumferential portion and the cover; and
jetting the water-soluble coolant into the gap when rotating the milling tool to cut a workpiece.

15. A method of manufacturing a milling tool, the method comprising:
preparing a tool body including
an outer circumferential portion having an upper end and a lower end, and
an end portion located at the lower end of the outer circumferential portion;
drilling an outer circumferential surface of the tool body to form a jetting port in the outer circumferential surface of the tool body, the jetting port being configured to allow a coolant to jet;
attaching an insert including a cutting edge to the tool body so that the cutting edge protrudes from the end portion; and
attaching a cover to the tool body so as to cover the jetting port, the cover surrounding the outer circumferential portion, with a gap lying between the outer circumferential portion and the cover.
